(19) United States
(12) Patent Application Publication
(10) Pub. No.: US 2026/0147514 A1
(43) Pub. Date: May 28, 2026

(54) IMAGE FORMING SYSTEM

(71) Applicant: KYOCERA Document Solutions Inc., Osaka (JP)

(72) Inventor: Naoki SEKIOKA, Osaka (JP)

(73) Assignee: KYOCERA Document Solutions Inc., Osaka (JP)

(21) Appl. No.: 19/393,545

(22) Filed: Nov. 18, 2025

(30) Foreign Application Priority Data
Nov. 27, 2024 (JP) 2024-206768

(51) Int. Cl. G06F 3/12

(52) U.S. Cl. CPC G06F 3/1263; G06F 3/1205; G06F 3/121; G06F 3/1234; G06F 3/1267

(57) ABSTRACT

When an error occurs in an image forming apparatus before execution of an interrupting print job, an interruption decider compares between an error type and property information of the interrupting print job, thereby deciding whether the interrupting print job is executable with the error remaining unfixed. When the interruption decider decides that the interrupting print job is executable, with the error remaining unfixed, the image forming apparatus suspends a preceding job and shifts the job to be executed to the interrupting print job, and executes the interrupting print job. When the error is fixed thereafter, a controller of the image forming apparatus resumes the execution of the preceding job, according to a print queue.

### INCORPORATION BY REFERENCE

This application claims priority to Japanese Patent Application No. 2024-206768 filed on Nov. 27, 2024, the entire contents of which are incorporated by reference herein.

### BACKGROUND

The present disclosure relates to an image forming system, including an image generating device and an image forming apparatus.

Many of existing image forming apparatuses, such as a multifunction peripheral, are configured to receive a print job from an image generating device connected via a network, to perform an image forming operation. Normally, the image forming apparatus executes the print jobs in the order that they have been received. However, for example, a printer device is known that temporarily suspends the ongoing print job, to allows another print job to interrupt, and resume the suspended print job, after the other print job is finished.

### SUMMARY

The disclosure proposes further improvement of the foregoing technique.

In an aspect, the disclosure provides an image forming system including an image generating device, and an image forming apparatus that performs data communication with the image generating device.

The image generating device includes a first control device, a print job storage device, a first communication device, and an input device. The first control device includes a processor, and acts as a job generator and a first controller, when the processor executes a control program. The job generator generates a print job. In the print job storage device, the print job is stored. The first communication device performs data communication with the image forming apparatus. The input device receives an input of an interrupting print job to be executed with priority, selected out of the print jobs stored in the print job storage device. The first controller transmits property information and an execution request of the interrupting print job, from the first communication device to the image forming apparatus, when the input device receives the input of the selected interrupting print job.

The image forming apparatus includes a second control device, a second communication device, and an image forming device. The second control device includes a processor, and acts as a second controller and an interruption decider, when the processor executes a control program. The second communication device performs data communication with the image generating device. The image forming device forms an image on a recording medium. The second controller causes the image forming device to execute the print job, received from the image generating device via the second communication device. The interruption decider decides, when an operation of the image forming device according to the ongoing print job is suspended owing to an error, whether the interrupting print job is executable with the error remaining unfixed, on a basis of the property information received from the image generating device via the second communication device.

Upon deciding that the interrupting print job is executable, the interruption decider of the image forming apparatus transmits readiness information indicating that the interrupting print job is ready to be executed, to the image generating device via the second communication device. The first controller of the image generating device transmits the interrupting print job to the image forming apparatus, upon receipt of the readiness information from the image generating device via the first communication device. The second controller of the image forming apparatus executes an operation specified by the interrupting print job received from the image generating device via the second communication device, in priority to the print job suspended.

### BRIEF DESCRIPTION OF THE DRAWINGS

FIG. 1 is a schematic drawing showing an image forming system;

FIG. 2 is a block diagram showing an electrical configuration of an image forming apparatus and an image generating device;

FIG. 3 is a sequence chart for explaining a process performed when the image generating device transmits an interrupting print job to the image forming apparatus;

FIG. 4 is a sequence chart for explaining another process performed when the image generating device transmits the interrupting print job to the image forming apparatus; and

FIG. 5 is a sequence chart for explaining another process performed when the image generating device transmits the interrupting print job to the image forming apparatus.

### DETAILED DESCRIPTION

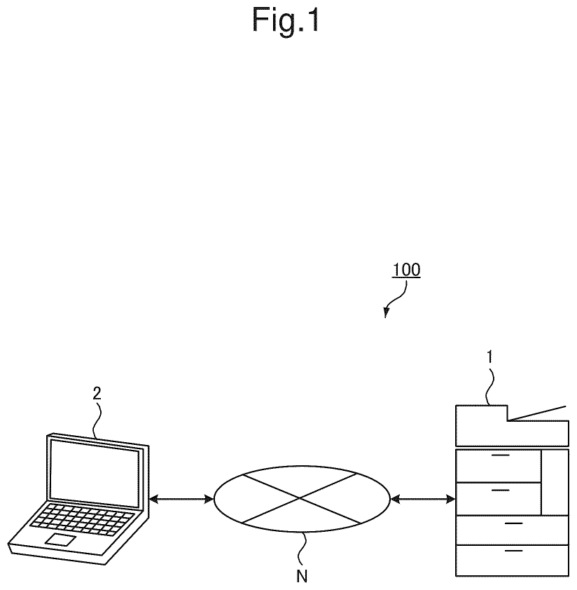

FIG. 1 is a schematic drawing showing an image forming system 100 according to an embodiment of the disclosure. The image forming system 100 includes an image forming apparatus 1 and an image generating device 2.

The image forming apparatus 1 prints an image read from a document, or an image transmitted from the image generating device 2, on a sheet. The image generating device 2 is an electronic terminal device such as a personal computer or a tablet, and generates a print job to be executed by the image forming apparatus 1.

The network N includes, for example, a local area network (LAN) or the internet, which enables transmission and reception of data. In this embodiment, the image forming apparatus 1 and the image generating device 2 performs data communication with each other, via the network N.

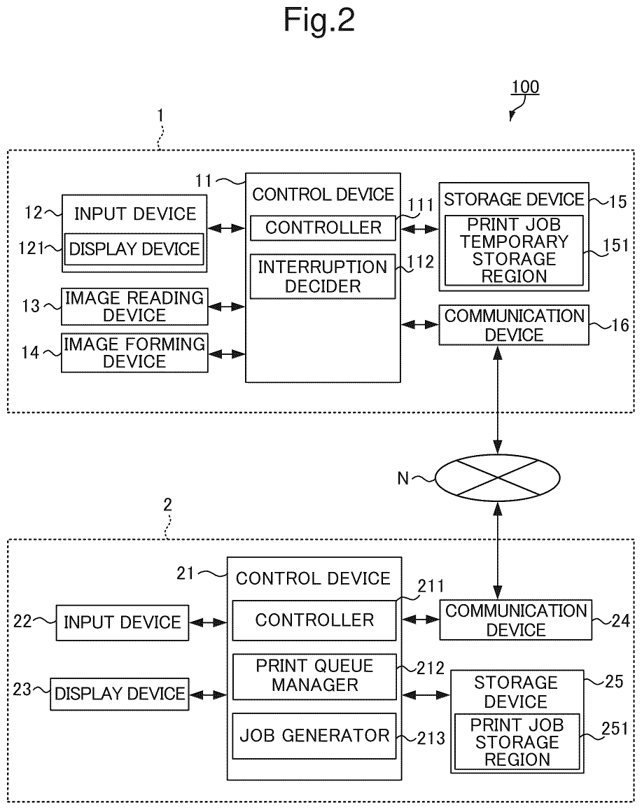

FIG. 2 is a block diagram showing an electrical configuration of the image forming apparatus 1 and the image generating device 2, according to the embodiment of the disclosure. The image forming apparatus 1 includes a control device 11, an input device 12, an image reading device 13, an image forming device 14, a storage device 15, and a communication device 16. The image forming apparatus 1 may be a copier, a printer, or a facsimile machine, or a multifunction peripheral having the mentioned functions. The image forming apparatus 1 may be either of an electrophotographic image forming apparatus, and an inkjet image forming apparatus.

The input device 12 includes hard keys such as an enter key and a start key, for realizing an operation and confirming various settings, and also a display device 121. The display device 121 includes, for example, a liquid crystal display (LCD) or an organic light-emitting diode (OLED) display, and displays operation screens and messages. The display device 121 may be integrally constituted with a touch panel.

The image reading device 13 includes a scanner, to read the image of a document and acquire image data. The image forming device 14 is based on the electrophotographic or inkjet printing method, and prints an image on a sheet, according to the image data acquired by the image reading device 13, or a print job transmitted from the image generating device 2.

The storage device 15 is a large-capacity storage medium such as a solid-state drive (SSD) or a hard disk drive (HDD), for storing the image data, various programs, and data tables, and includes a print job temporary storage region 151. The print job temporary storage region 151 is a region for temporarily storing the print job received from the image generating device 2.

The communication device 16 includes a communication module for transmitting and receiving various data, in addition to the print job, to and from an external device such as the image generating device 2, via the network N such as the internet. The communication device 16 exemplifies the second communication device in the disclosure.

The control device 11 includes a processor, a random-access memory (RAM), and a read-only memory (ROM). The processor is, for example, a central processing unit (CPU), a micro processing unit (MPU), or an application-specific integrated circuit (ASIC). The control device 11 acts as a controller 111 and an interruption decider 112, when the processor executes a control program stored in the ROM. The controller 111 serves to control the overall operation of the image forming apparatus 1. The controller 111 exemplifies the second controller in the disclosure.

In addition, when the communication device 16 receives an execution request of an interrupting print job from the image generating device 2, while the image forming device 14 is executing a print job, the controller 111 suspends the execution of the ongoing print job, and causes the image forming device 14 to execute the interrupting print job.

When the operation of the image forming device 14 according to the ongoing print job is suspended owing to an error, the interruption decider 112 decides whether the interrupting print job is executable with the error remaining unfixed, on the basis of property information received from the image generating device 2 via the communication device 16. The property information refers to data representing, for example, a page layout or section structure, indicating what type of nature the object of the print job possesses.

Further details are described hereunder. The print job that the image forming device 14 is executing before the execution of the interrupting print job will hereinafter be referred to as preceding job. When the operation of the image forming device 14 of the image forming apparatus 1 is suspended owing to an error, during the execution of the preceding job, the interruption decider 112 decides whether the interrupting print job can be executed under the current situation.

(1) Examples of the cases where the interruption decider 112 decides that the interrupting print job can be executed, even though the error is unfixed include: (i) the error is running-out of the sheet of A4 size, but the sheet size of the interrupting print job is other than the A4 size (provided that the sheet for the interrupting print job has not run out), (ii) although a mismatch error has occurred because of discordance in sheet setting between the preceding job and the tray of the image forming apparatus 1, there is no discordance in sheet setting between the interrupting print job and the tray of the image forming apparatus 1, and (iii) the ink in one of the color ink cartridges being used for the preceding job has run out, but the interrupting print job is a monochrome printing job which does not use the color ink. However, the errors that allow the interrupting print job to be executed are not limited to the above.

When the interruption decider 112 decides that the interrupting print job can be executed with the error remaining unfixed, the controller 111 causes the image forming device 14 to suspend the preceding job, and execute the interrupting print job in priority to the preceding job. In other words, the interrupting print job is executed with priority, despite the user not having fixed the error, and therefore the interrupting print job can be promptly started and executed.

(2) On the contrary, there may be errors that make the interruption decider 112 decide that the interrupting print job is unable to be executed, because the type of the error also affects the interrupting print job. Examples of the cases where the interruption decider 112 decides that the interrupting print job is unable to be executed, because the error is unfixed, are as cited hereunder.

(i) When the waste toner container or waste ink box has become full, and (ii) when paper jam has occurred on the transport route. In such cases, the controller 111 is unable to cause the image forming device 14 to execute the interrupting print job. Accordingly, the controller 111 suspends the execution of the preceding job, and causes the image forming device 14, after the error is fixed by the user, to execute the interrupting print job with priority. However, the errors that make the interrupting print job inexecutable are not limited to the above.

The image generating device 2 includes a control device 21, an input device 22, a display device 23, a communication device 24, and a storage device 25. The input device 22 includes a keyboard, and a pointing device. The input device 22 receives the interrupting print job to be executed with priority, selected by the user out of the print jobs stored in a print job storage region 251. The input device 22 exemplifies the input device in the disclosure.

The display device 23 includes, for example, a liquid crystal display or an organic light-emitting diode display, and displays operation screens and messages. The communication device 24 includes a communication module for transmitting and receiving various data, to and from an external device such as the image forming apparatus 1, via the network N such as the internet. The storage device 25 is a large-capacity storage medium such as an SSD or an HDD, for storing the image data, various programs, and data tables.

The control device 21 includes a processor, a RAM, and a ROM. The processor is, for example, a CPU, an MPU, or an ASIC. The control device 21 acts as a controller 211, a print queue manager 212, and a job generator 213, when the processor executes a control program stored in the ROM.

The controller 211 serves to control the overall operation of the image generating device 2. The print queue manager 212 sorts the order of execution of the print jobs stored in the print job storage region 251 of the image forming apparatus 1. The job generator 213 generates the print job. The print job storage region 251 is a storage region in the storage device 25, and the print job generated by the job generator 213 is stored in the print job storage region 251, by the controller 211.

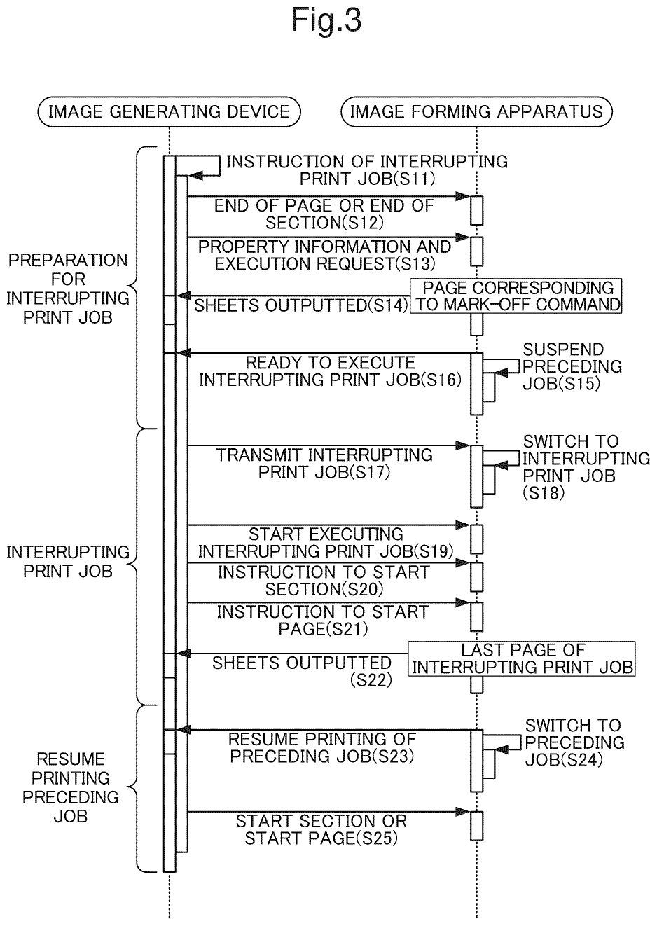

Hereunder, the management of the interrupting print job, performed by the image generating device 2 will be described. FIG. 3 is a sequence chart showing a basic process, performed when the preceding job has not suffered an error before the execution of the interrupting print job, in other words when the interrupting print job has arisen.

When the input device 22 of the image generating device 2 receives the input of the interrupting print job to be executed with priority, selected out of the print jobs stored in the print job storage region 251 (S11), the controller 211 of the image generating device 2 generates a mark-off command indicating the point where the preceding job is to be suspended, and transmits the mark-off command to the image forming apparatus 1 via the communication device 24 (S12). When the interrupting print job arises, although it is the image forming apparatus 1 that suspends the preceding job and executes the operation according to the interrupting print job with priority, the timing that the image forming apparatus 1 is to suspend the preceding job is controlled by the image generating device 2.

The timing to suspend the preceding job may be, for example, a terminal end of a page, or a terminal end of a section, with respect to the images on a plurality of pages to be printed according to the print job. For example, when the preceding job specifies printing of one set, the image generating device 2 transmits the mark-off command indicating the terminal end of the page, to the image forming apparatus 1. When the preceding job specifies printing of a plurality of sets, the image generating device 2 transmits the mark-off command indicating the terminal end of the section, in other words the end of one set, to the image forming apparatus 1.

Then the controller 211 of the image generating device 2 transmits the property information and the execution request of the interrupting print job, to the image forming apparatus 1 via the communication device 24 (S13). On the part of the image forming apparatus 1, the controller 111 causes the image forming device 14, upon receipt of the property information and the execution request of the interrupting print job, via the communication device 16, to execute the ongoing print job (i.e., preceding job) to the terminal end of the page or terminal end of the section indicated by the mark-off command received. When the printing up to the point indicated by the mark-off command is finished, the controller 111 transmits a signal indicating that the sheets have been outputted up to the point of the mark-off command, to the image generating device 2 via the communication device 16 (S14), suspends the preceding job (S15), and transmits readiness information indicating that the interrupting print job is ready to be executed, to the image generating device 2 via the communication device 16 (S16). When suspending the preceding job, the controller 111 retracts a job management object of the preceding job.

Upon receipt of the readiness information via the communication device 24, the controller 211 of the image generating device 2 transmits the interrupting print job to the image forming apparatus 1, via the communication device 24 (S17).

In the image forming apparatus 1, the controller 111 switches, upon receipt of the interrupting print job via the communication device 16, the print job to be executed to the interrupting print job (S18). In other words, the controller 111 switches the object of printing to the job management object of the interrupting print job.

Then the controller 211 of the image generating device 2 transmits an instruction to start the execution of the interrupting print job, to the image forming apparatus 1 via the communication device 24 (S19), and also instruction signals for starting the section (S20) and starting the page (S21), to the image forming apparatus 1.

Upon receipt of the instruction to start the execution and the instruction signals via the communication device 16, the controller 111 of the image forming apparatus 1 executes the operation according to the interrupting print job, and causes the image forming device 14 to perform the printing operation according to the interrupting print job. When the printing of the last page of the interrupting print job, and the outputting of the printed sheets are finished, the controller 111 transmits a signal indicating that the sheets have been outputted, to the image generating device 2 via the communication device 16 (S22).

After finishing the interrupting print job, the controller 111 of the image forming apparatus 1 transmits a signal indicating that the preceding job, thus far suspended, is ready to be resumed, to the image generating device 2 via the communication device 16 (S23), and switches the print job to be executed to the preceding job (S24).

Upon receipt of the signal indicating that the preceding job is ready to be resumed, via the communication device 24, the controller 211 of the image generating device 2 transmits the section number or page number, from which the preceding job is to be resumed, to the image forming apparatus 1 via the communication device 24 (S25). Upon receipt of the section number or page number via the communication device 16, the controller 111 of the image forming apparatus 1 causes the image forming device 14 to resume the printing operation of the preceding job, according to the section number or page number received.

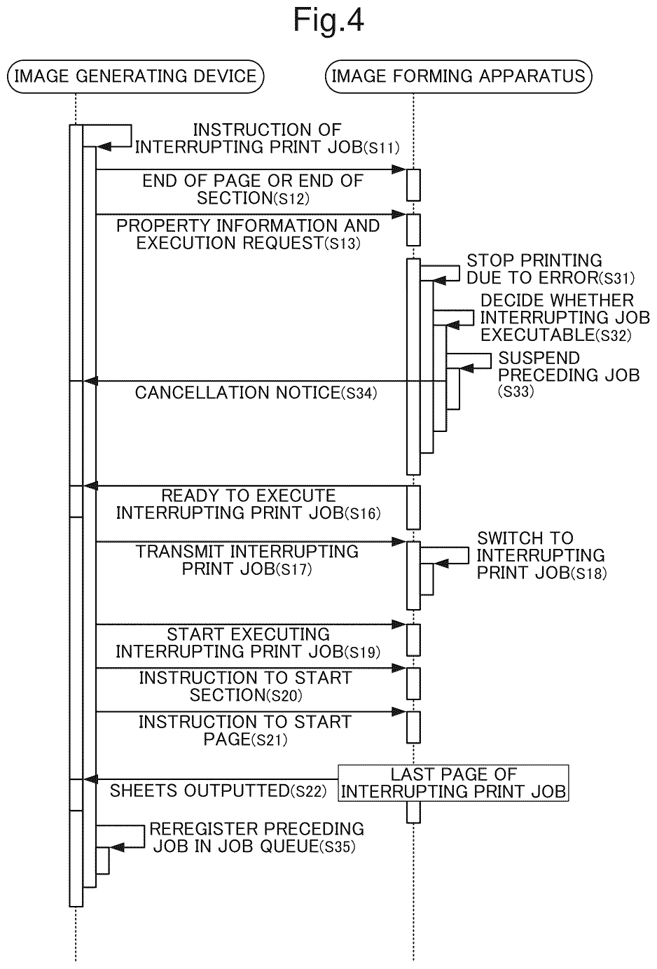

Hereunder, the management of the interrupting print job, performed by the image generating device 2 when an error occurs during the execution of the preceding job, before the execution of the interrupting print job, but the interrupting print job can be executed though the error is unfixed, will be described. FIG. 4 is a sequence chart showing a process performed when an error has occurred, but (1) the interrupting print job is executable though the error is unfixed. The steps in FIG. 4 given the same numeral as FIG. 3 represent the same operation as specified in FIG. 3.

When the input device 22 of the image generating device 2 receives the input of the interrupting print job to be executed with priority, selected out of the print jobs stored in the print job storage region 251 (S11), the controller 211 of the image generating device 2 generates the mark-off command indicating the point where the preceding job is to be suspended, and transmits the mark-off command to the image forming apparatus 1 via the communication device 24 (S12).

Then the controller 211 of the image generating device 2 transmits the property information and the execution request of the interrupting print job, to the image forming apparatus 1 via the communication device 24 (S13). Upon receipt of the property information and the execution request of the interrupting print job, via the communication device 16, the controller 111 of the image forming apparatus 1 starts the operation of executing the ongoing print job (i.e., preceding job) up to the terminal end of the page or terminal end of the section indicated by the mark-off command.

When an error occurs in the image forming apparatus 1 during the execution of the preceding job, the controller 111 causes the image forming device 14 to suspend the operation with respect to the object indicated by the preceding job (S31). Then the interruption decider 112 decides whether the interrupting print job is executable with the error remaining unfixed, on the basis of the property information of the interrupting print job received at S13 (S32). In this case, the interruption decider 112 decides that the interrupting print job is executable with the error remaining unfixed, on the basis of the property information. The interruption decider 112 suspends and cancels the execution of the preceding job (S33).

The controller 111 then transmits a cancellation notice of the preceding job to the image generating device 2 via the communication device 16 (S34), and also transmits the readiness information indicating that the interrupting print job is ready to be executed, to the image generating device 2 via the communication device 16 (S16).

After S16, upon receipt of the readiness information via the communication device 24, the controller 211 of the image generating device 2 transmits the interrupting print job to the image forming apparatus 1, via the communication device 24 (S17).

Upon receipt of the interrupting print job via the communication device 16, the controller 111 of the image forming apparatus 1 switches the print job to be executed, to the interrupting print job (S18). In the image forming apparatus 1, thereafter, the image forming device 14 performs, under the control of the controller 111, the operation according to the interrupting print job, and according to the instructions received from the image forming apparatus 1, similarly to the sequence chart of FIG. 3. When the printing of the last page of the interrupting print job, and the outputting of the sheets are finished, the controller 111 transmits the signal indicating that the sheets have been outputted, to the image generating device 2 via the communication device 16 (S22).

When the signal indicating that the sheets have been outputted is received by image generating device 2 via the communication device 24, the print queue manager 212 reregisters the preceding job, which was suspended at S33, at the tail end of the print queue, among the print jobs stored in the print job storage region 251 (S35). This is because, since the error has not been fixed at this point and the preceding job is inexecutable, higher priority is given to other print jobs standing by, which may be executable despite the error remaining unfixed.

Here, the print queue manager 212 may reregister the preceding job suspended at S33, at the top of the print queue, among the print jobs stored in the print job storage region 251 (S35). In this case, although the error has not been fixed and the preceding job is unable to be immediately executed, the controller 111 resumes the printing operation starting from the preceding job, according to the print queue, as soon as the error is fixed.

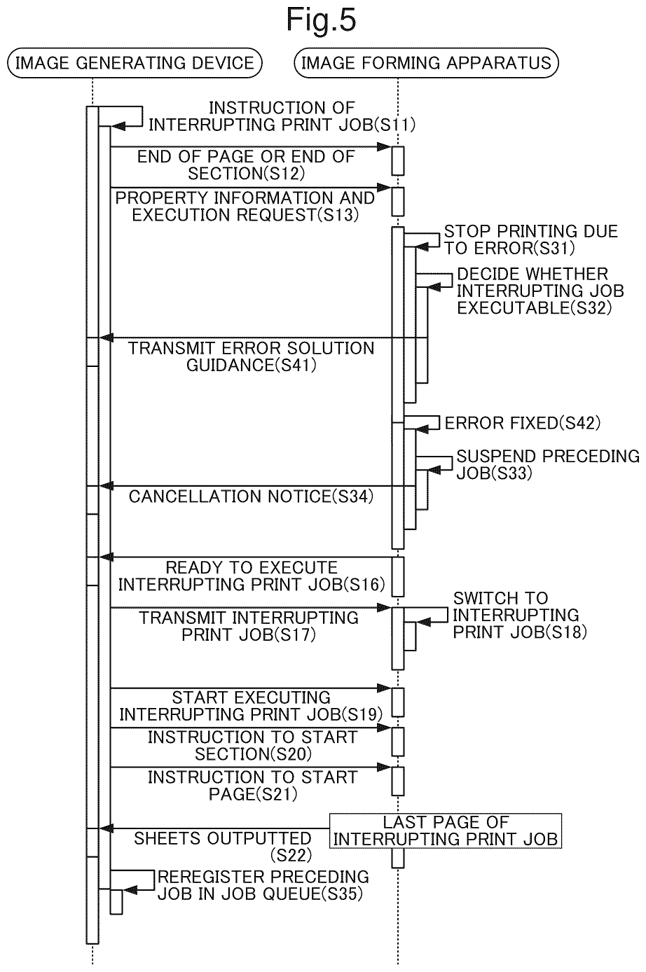

Hereunder, the management of the interrupting print job, performed by the image generating device 2 when an error occurs during the execution of the preceding job, before the execution of the interrupting print job, and the interrupting print job is inexecutable because the error is unfixed, will be described. FIG. 5 is a sequence chart showing a process performed when an error has occurred during the execution of the preceding job, and (2) the interrupting print job is inexecutable because the error is unfixed. The steps in FIG. 5 given the same numeral as FIG. 3 and FIG. 4 represent the same operation as specified in the preceding drawings.

When an error occurs in the image forming apparatus 1 during the execution of the preceding job, the controller 111 causes the image forming device 14 to suspend the operation with respect to the object indicated by the preceding job (S31). Then the interruption decider 112 decides whether the interrupting print job is executable with the error remaining unfixed, on the basis of the property information of the interrupting print job received at S13 (S32). In this case, the interruption decider 112 decides that the interrupting print job is inexecutable as long as the error is unfixed, on the basis of the property information.

Then the controller 111 transmits solution information including error solution guidance, to the image generating device 2 via the communication device 16 (S41). The error solution guidance refers to the information indicating an operation necessary for fixing the error that has occurred, and various types of error solution guidance are stored in the storage device 15, with respect to each type of the error. The controller 111 retrieves the error solution guidance corresponding to the error that has occurred, from the storage device 15, and transmits the retrieved error solution guidance to the image generating device 2 via the communication device 16, as the solution information.

Upon receipt of the solution information via the communication device 24, the controller 211 of the image generating device 2 causes the display device 23 to display an error message indicated by the solution information.

It is assumed here that, in view of the error message displayed on the display device 23 of the image generating device 2, the user or the manager has performed the designated operation with respect to the image forming apparatus 1, and fixed the error. When the controller 111 of the image forming apparatus 1 recognizes that the error has been fixed, for example on the basis of signals from built-in sensors (S42), the interruption decider 112 suspends and cancels the execution of the preceding job (S33).

Then the controller 111 transmits the cancellation notice of the preceding job to the image generating device 2 via the communication device 16 (S34), and also transmits the readiness information indicating that the interrupting print job is ready to be executed, to the image generating device 2 via the communication device 16 (S16).

Upon receipt of the readiness information via the communication device 24, the controller 211 of the image generating device 2 transmits the interrupting print job to the image forming apparatus 1, via the communication device 24 (S17).

Upon receipt of the interrupting print job via the communication device 16, the controller 111 of the image forming apparatus 1 switches the print job to be executed, to the interrupting print job (S18).

In the image forming apparatus 1, thereafter, the image forming device 14 performs, under the control of the controller 111, the operation according to the interrupting print job, and according to the instructions received from the image forming apparatus 1, similarly to the sequence chart of FIG. 3 and FIG. 4. In the image generating device 2, when the signal indicating that the sheets have been outputted is received via the communication device 24, the print queue manager 212 reregisters the preceding job suspended at S33, at the top of the print queue, among the print jobs stored in the print job storage region 251 (S35). This is because the preceding job can be immediately resumed, since the error has already been fixed.

As described thus far, when an error occurs in the image forming apparatus 1 before the execution of the interrupting print job, the interruption decider 112 decides whether the interrupting print job is executable with the error remaining unfixed. When the interrupting print job is executable with the error remaining unfixed, the controller 111 cancels the preceding job, and causes the image forming device 14 to execute the interrupting print job. Accordingly, the interrupting print job can be promptly executed first, despite the user not having fixed the error, and therefore the standing-by print jobs can be efficiently executed, which leads to improved convenience in use of the image forming apparatus 1.

The disclosure may be modified in various manners, without limitation to the foregoing embodiment. For example, the case where there is a single interrupting print job, with respect to the case of (2), where the preceding job and the interrupting print job are inexecutable because the error is unfixed. When there are a plurality of interrupting print jobs (e.g., interrupting print job A and interrupting print job B), the interruption decider 112 decides whether the interrupting print job is executable though the error is unfixed, with respect to all the interrupting print jobs.

For example, when the interruption decider 112 decides that, because the error is unfixed yet, the preceding job and the interrupting print job A are inexecutable, but the interrupting print job B is executable, the controller 111 suspends the execution of the preceding job and the interrupting print job A and switches the job to be executed to the interrupting print job B, to execute the interrupting print job B first. Thus, when there are a plurality of interrupting print jobs, the interruption decider 112 may select the interrupting print job that is executable though the error is unfixed, so that the controller 111 may execute the selected interrupting print job.

According to the foregoing embodiment, when the operation of the image forming apparatus is stopped because of an error, the interruption decider decides whether the interrupting print job is executable with the error remaining unfixed. When the interrupting print job is executable with the error remaining unfixed, the controller causes the image forming device to suspend the preceding job, and execute the interrupting print job. Accordingly, the interrupting print job can be promptly executed first, despite the user not having fixed the error, and therefore the convenience in use of the image forming apparatus 1 can be improved.

In the case of existing image forming apparatuses, unlike the foregoing embodiment, when the image generating device transmits a print job B as a forcibly interrupting job, while the image forming apparatus is executing a print job A, normally the image forming apparatus executes the print job B after the execution of the print job A, though other print jobs are specified in the print queue. However, when an error occurs during the execution of the print job A and the operation of the image forming apparatus is stopped, the print job B is not executed until the error is fixed, and the execution of the print job A is resumed and completed, despite the print job B being executable though the error is unfixed. Therefore, neither of the print job A and the print job B become executable, unless and until the user or manager fixes the error, which disables the standing-by print jobs from being efficiently executed.

In contrast, with the arrangement according to the foregoing embodiment, the interrupting print job can be promptly made executable, even when an error occurs in the image forming apparatus during the execution of the preceding print job.

The configurations and processings according to the foregoing embodiment, described with reference to FIG. 1 to FIG. 5, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming system comprising:
an image generating device; and
an image forming apparatus that performs data communication with the image generating device,
wherein the image generating device includes:
a first control device including a processor, and configured to act as a job generator that generates a print job, and a first controller, when the processor executes a control program;
a print job storage device in which the print job is stored;
a first communication device that performs data communication with the image forming apparatus; and
an input device that receives an input of an interrupting print job to be executed with priority, selected out of the print jobs stored in the print job storage device,
the first controller transmits property information and an execution request of the interrupting print job, from the first communication device to the image forming apparatus, when the input device receives the input of the selected interrupting print job,
the image forming apparatus includes:
a second communication device that performs data communication with the image generating device;
an image forming device that forms an image on a recording medium; and
a second control device including a processor, and configured to act, when the processor executes a control program, as: a second controller that causes the image forming device to execute the print job, received from the image generating device via the second communication device; and
an interruption decider that decides, when an operation of the image forming device according to the ongoing print job is suspended owing to an error, whether the interrupting print job is executable with the error remaining unfixed, on a basis of the property information received from the image generating device via the second communication device,
the interruption decider of the image forming apparatus transmits, upon deciding that the interrupting print job is executable, readiness information indicating that the interrupting print job is ready to be executed, to the image generating device via the second communication device,
the first controller of the image generating device transmits the interrupting print job to the image forming apparatus, upon receipt of the readiness information from the image generating device via the first communication device, and
the second controller of the image forming apparatus executes an operation specified by the interrupting print job received from the image generating device via the second communication device, in priority to the print job suspended.

2. The image forming system according to claim 1,
wherein the image generating device further includes a print queue manager that sorts an order of execution of the print job, and
the print queue manager sets the suspended print job at a tail end of a print queue, after the image forming apparatus has executed the interrupting print job.

3. The image forming system according to claim 1,
wherein, in a case of deciding that the interrupting print job is inexecutable because the error is unfixed, the interruption decider of the image forming apparatus transmits the readiness information to the image generating device via the second communication device, after the error is fixed.

4. The image forming system according to claim 3,
wherein, in a case of deciding that the interrupting print job is inexecutable because the error is unfixed, the interruption decider of the image forming apparatus transmits solution information indicating solution guidance of the error, to the image generating device via the second communication device.

5. The image forming system according to claim 4,
wherein, when the interruption decider of the image forming apparatus transmits the readiness information to the image generating device via the second communication device, after the error is fixed, and
the second controller of the image forming apparatus receives the interrupting print job corresponding to the readiness information, from the image generating device via the second communication device, the second controller executes an operation according to the interrupting print job received, in priority to the suspended print job.

6. The image forming system according to claim 5,
wherein the first control device of the image generating device further acts as a print queue manager that sorts an order of execution of the print job, when the processor executes the control program, and
the print queue manager sets the suspended print job at a top of a print queue, after the image forming apparatus has executed the interrupting print job.
